(19) United States
(12) Patent Application Publication
(10) Pub. No.: US 2009/0014974 A1
(43) Pub. Date: Jan. 15, 2009

(54) WHEELED SKI AND EQUIPMENT-CARRYING DEVICE

(76) Inventors: Mara VanVORST, Scotia, NY (US); Doug VanVORST, Scotia, NY (US)

Correspondence Address: HESLIN ROTHENBERG FARLEY & MESITI PC, 5 COLUMBIA CIRCLE, ALBANY, NY, 12203, US

(21) Appl. No.: 12/171,482

(22) Filed: Jul. 11, 2008

Related U.S. Application Data
(60) Provisional application No. 60/949,308, filed on Jul. 12, 2007.

(51) Int. Cl. B62B 1/16; B62B 1/26

(52) U.S. Cl. 280/47.26; 280/47.19; 280/47.315

(57) ABSTRACT

A ski bag incorporated with a frame having wheels and a handle, capable of holding a family's skis and/or snowboard(s), enabling them to wheel the bag to a lodge, automobile, etc.; and which may be easily stored in a typical ski locker.

### CROSS-REFERENCE TO RELATED APPLICATION

This application claims the benefit of U.S. provisional patent application Ser. No. 60/949,308, filed Jul. 12, 2007, which is hereby incorporated herein by reference in its entirety.

### TECHNICAL FIELD

The present invention relates to a wheeled apparatus for carrying skis and/or snowboard(s) and related equipment.

### BACKGROUND OF THE INVENTION

Conventional skiing and snowboarding groups, and families, must carry a great deal of equipment from their car to the mountain. Most of the time, they must carry the equipment from a parking lot or a lodge with a long walk to the mountain. Moreover, many families have smaller children who cannot carry their own skis and ski boot bags, therefore, their parents must carry all of the heavy and cumbersome equipment. There is a need for equipment which can carry all of a family's ski equipment, easily rollable between the mountain/lodge/automobile, etc., and then easily stored in a typical equipment bag location.

Equipment exists to hold a pair of skis, allowing a single skier to carry or roll equipment to the mountain. Bags to hold ski boots are used by most skiers as well as bags which carry skis, but a rolling bag which carries both skis and ski boots for an entire family is needed. This bag must be capable of rolling over snow and up stairs, but also be capable of being stored away in the same manner as traditional ski equipment bags without requiring additional storage room. It should also have additional component bags which are detachable so the weight of loading can be decreased when lifting the remaining equipment.

The present invention addresses these problems, by providing a ski bag incorporated with a frame having wheels and a handle, capable of holding a family's ski equipment, enabling them to wheel the bag to a lodge, automobile, etc.; and which can be easily stored in a typical ski locker.

### SUMMARY OF THE INVENTION

The shortcomings of the prior art are addressed, and additional advantages are provided by the present invention which in one aspect is a specially-designed ski bag, with wheels, which will carry both skis and snowboards as well as all other ski equipment. The bag/frame combination (referred to herein as a “cart” without limitation) is able to carry skis and/or snowboard(s). The cart is light enough when loaded (not including skis) to lift in and out of a vehicle but strong enough to carry a family of 4's equipment (including skis and or snowboard) pulled by one person. An upper component can be detachable, and can carry ski helmets, or ski clothing including gloves, goggles, hats, and other snowsport apparel. The bottom can be durable and vented and will carry the ski boots. The entire cart can be pulled by a single handle which can be concealed once at the mountain. After the skis have been unloaded outside the lodge, the bag can then be stored away like all other ski bags.

In that regard, the present invention is directed to, in one aspect, a ski cart having a bag portion with a perimeter area for holding skis and/or snowboard(s) along at least two sides thereof; the bag portion having an interior portion for holding ski equipment; the bag portion having a separable portion for holding additional ski equipment; and a frame for supporting the bag during transit thereof, the frame including a handle for pulling and wheels for rolling the ski cart. The perimeter area may include a lower pocket into which the skis and/or snowboard(s) can be inserted and vertically supported in an upright position, and an upper strap portion for horizontally stabilizing the skis and/or snowboards. The pocket and strap along at least one side of the ski cart have detachable attachment means for lengthening or shortening the space within which the skis and/or snowboard(s) are placed, to accommodate different widths of skis and/or snowboards. The bag and/or frame may or may not be collapsible.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter regarded as the invention is particularly pointed out and distinctly claimed at the conclusion of the specification. The foregoing and other objects, features, and advantages of the invention are apparent from the following detailed description taken in combination with the accompanying drawings in which:

FIG. 1 is a perspective view of the ski cart of the present invention;

FIG. 2 is another perspective view of the ski cart of the present invention from a different angle;

FIG. 3 is an expanded, perspective view of the “bag” portion of the present invention showing the pocket/strap combinations for holding the skis and/or snowboards;

FIG. 4 is an expanded, perspective view of both, separable bag portions of the present invention;

FIG. 5 is a perspective view of the frame portion of the present invention showing the handle and wheels; and

FIG. 6 shows the wheel base portion of the frame of the present invention.

### DETAILED DESCRIPTION OF THE INVENTION

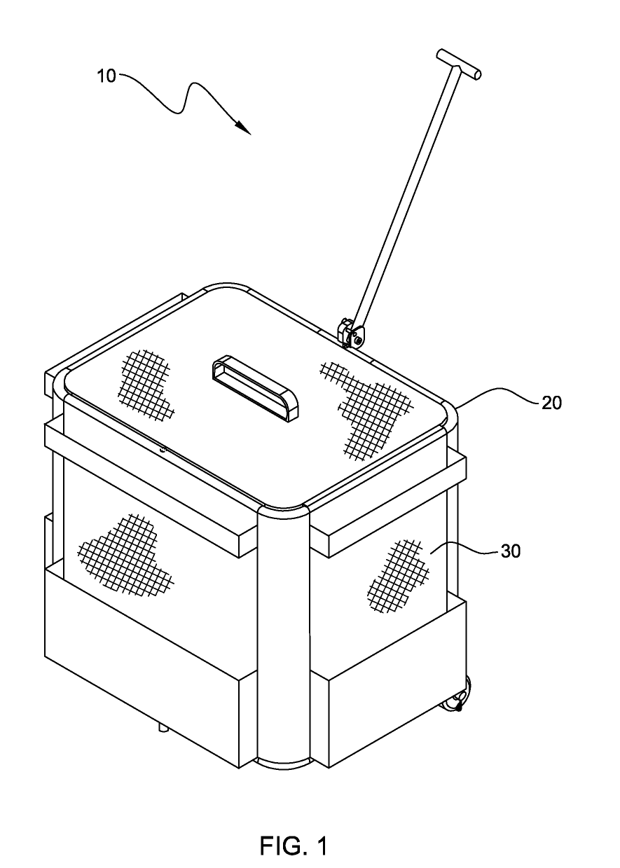

With reference to FIG. 1, ski cart 10 according to the present invention is shown, having a frame portion 20 and a bag portion 30. The frame may be implemented internal or external to the bag portion 20, and be fabricated from, e.g., a lightweight rust-proof metal e.g., steel, aluminum, composite, etc. The bag portion may be a flexible or rigid material, possibly cordura or other fabric traditionally used for luggage or travel packs; and as shown approximately 30″ high×30″ length/width. Therefore the term “bag” is used herein without limitation to connote a flexible carrier or completely rigid container, or any equivalent variants thereof.

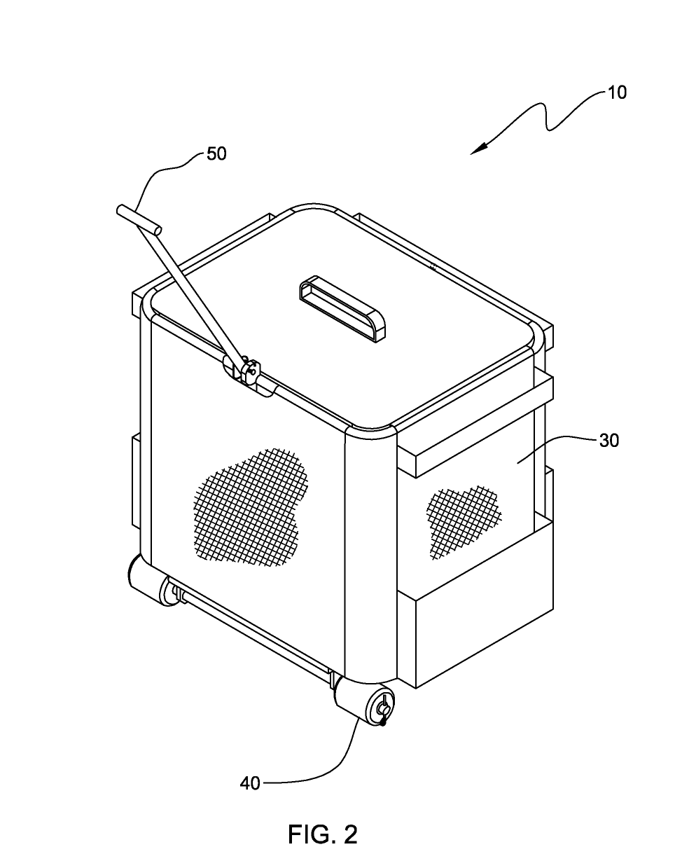

FIG. 2 is a perspective view from a different angle, showing wheels 40 and extendable pulling handle 50 of the frame.

The bag may be designed to surround the internal frame. On the back side top of the carrier, an extendable handle 50 can pull the cart, which can fold down and can be concealed with a flap to hide the handle. The handle when lifted, stops at a precise angle to easily pull the cart. Also, on the back side rear, e.g., polyurethane 3.0 by 3.75 inch wheels 40 can be provided.

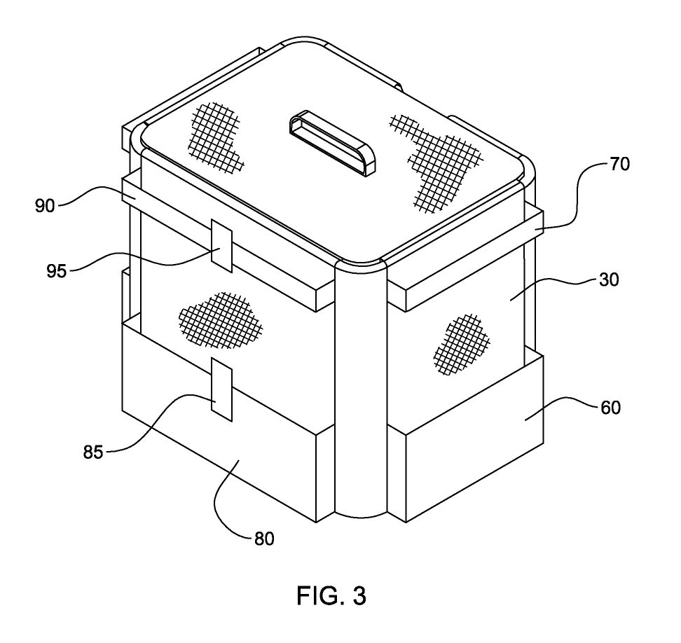

FIG. 3 is an expanded view of the bag showing pockets 60, 80 (e.g., reinforced cordura) along at least two sides for vertical support possibly including drainage vents at the bottom for draining excess moisture, along with straps 70, 90 for horizontal support and stability. The pockets and/or straps may have heavy/strong (e.g., velcro) attachments 85, 95 in their middle section so the pocket can be velcroed to form two pockets to hold skis or opened to hold a snowboard.

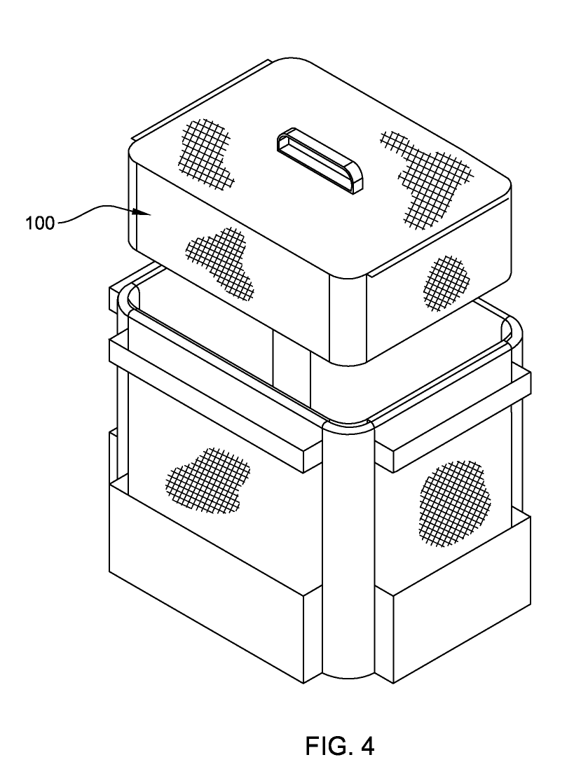

FIG. 4 shows an exemplary top section 100 of the bag portion, which can hold gloves, helmets, etc. and is detachable by, e.g., velcro, and can have a handle on top. Top section can also be implemented as any other exchangeable product such as a cooler, etc.

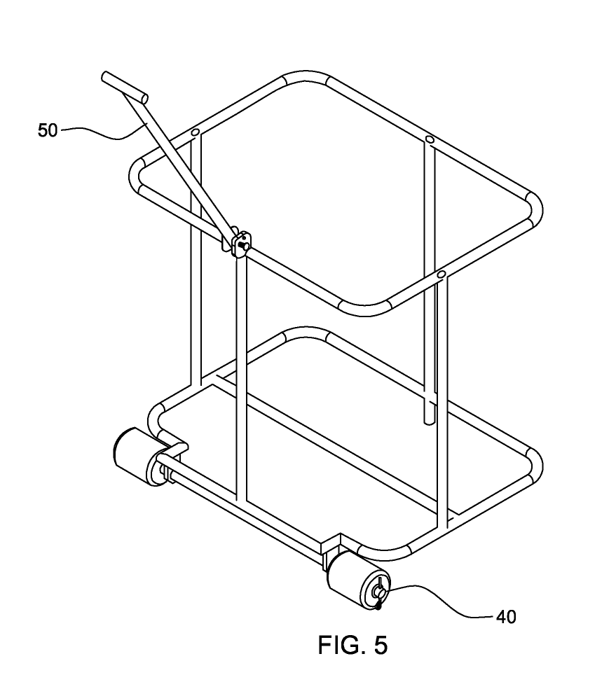

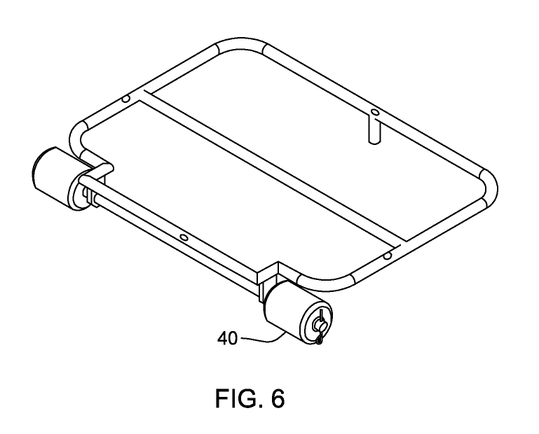

FIGS. 5 and 6 show additional detail of the frame with wheels 40 and handle 50, attached to a base thereof.

The bag and frame may or may not be constructed to collapse into a standard ski-area locker.

The ski cart of the present invention can allow a family or group of skiers to:
preload several (e.g., 2-4) pairs of ski boots in the ski cart unit.
lift the ski cart into a vehicle without breaking it apart.
carry 4 ski helmets in the attachable closure ski bag.
allow you to remove the ski cart from the back of the car and lengthen handle and load 4 pairs of skis into the ski cart.
the cart can also handle snowboard(s).
all skis can then be unloaded at the mountain and then the ski cart can be brought into the lodge for additional unpacking.
simply do the reverse to pack up and return to the car.
the ski cart travels through snow and up and down stairs.
it's weight unloaded can be as low as approx 11 lbs

The ski cart of the present invention takes the hassle out of skiing and lets you enjoy the entire day; a child can pull the cart to the mountain leaving the adults without anything to carry.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A ski cart, comprising:
a bag portion having perimeter area for holding skis and/or snowboard(s) along at least two sides thereof;
the bag portion having an interior portion for holding ski equipment;
the bag portion having a separable portion for holding additional ski equipment;
a frame for supporting the bag during transit thereof, the frame including a handle for pulling and wheels for rolling the ski cart.

2. The ski cart of claim 1, wherein the perimeter area includes a lower pocket into which the skis and/or snowboard(s) can be inserted and vertically supported in an upright position, and an upper strap portion for horizontally stabilizing the skis and/or snowboard(s).

3. The ski cart of claim 2, wherein the pocket and strap along at least one side of the ski cart have detachable attachment means for lengthening or shortening the space within which the skis and/or snowboard(s) are placed, to accommodate different widths of skis and/or snowboards.

4. The ski cart of claim 1, wherein the bag and/or frame are collapsible.

5. The ski cart of claim 1, wherein the bag portion has perimeter area for holding skis and/or snowboard(s) along at least three sides thereof, and a fourth side faces an extendable handle on the frame for pulling the ski cart.

6. The ski cart of claim 1, wherein the bag comprises a rigid and/or flexible material.

7. A rollable ski cart, comprising:
a bag portion having perimeter area for holding skis and/or snowboard(s) along at least two sides thereof; and
the bag portion having an interior portion for holding ski equipment;
wherein the perimeter area includes a lower pocket into which the skis and/or snowboard(s) can be inserted and vertically supported in an upright position, and an upper strap portion for horizontally stabilizing the skis and/or snowboard(s).

8. The ski cart of claim 7, wherein the pocket and strap along at least one side of the ski cart have detachable attachment means for lengthening or shortening the space within which the skis and/or snowboard(s) are placed, to accommodate different widths of skis and/or snowboards.

9. The ski cart of claim 7, wherein the bag and/or frame are collapsible.

10. The ski cart of claim 7, wherein the bag portion has perimeter area for holding skis and/or snowboard(s) along at least three sides thereof, and a fourth side faces an extendable handle on the frame for pulling the ski cart.

11. The ski cart of claim 7, wherein the bag portion has a separable portion for holding additional ski equipment, the ski cart further comprising:
a frame for supporting the bag during transit thereof, the frame including a handle for pulling and wheels for rolling the ski cart.

12. The ski cart of claim 7, wherein the bag comprises a rigid and/or flexible material.
